(19) United States
(12) Patent Application Publication
(10) Pub. No.: US 2015/0381751 A1
(43) Pub. Date: Dec. 31, 2015

(54) METHOD AND APPARATUS FOR PROXY OPERATION IN VEHICULAR COMMUNICATIONS

(71) Applicant: AUTOTALKS LTD., Kfar Netter (IL)

(72) Inventor: ONN HARAN, Bnei Dror (IL)

(21) Appl. No.: 14/616,719

(22) Filed: Feb. 8, 2015

Related U.S. Application Data
(60) Provisional application No. 62/018,821, filed on Jun. 30, 2014.

(51) Int. Cl. H04L 29/08; H04W 76/02

(52) U.S. Cl. CPC H04L 67/28; H04W 76/023; H04W 84/20

(57) ABSTRACT

Method and apparatus for proxy operation in a vehicular environment that includes a first plurality of ego-vehicles having vehicular communication capability (V2X vehicles) and respective sensors and a second plurality of vehicles without vehicular communication capability (non-V2X vehicles), a method embodiment comprising the steps of, in an ego-vehicle, determining that a particular vehicle observed by the respective ego-vehicle sensor is a non-V2X, proxy target vehicle, electing the ego-vehicle as a proxy server for the proxy target vehicle, and performing proxy transmission for the proxy target vehicle.

### CROSS REFERENCE TO RELATED APPLICATIONS

This application is related to and claims priority from U.S. Provisional Patent Application No. 62/018821 titled “Method and apparatus for arbitration of vehicular network transmission of vehicles detected by sensors” and filed Jun. 30, 2014, which is incorporated herein by reference in its entirety.

### FIELD

Embodiments disclosed herein relate in general to vehicular communications and in particular to vehicular communication proxy operation.

### BACKGROUND

Vehicle technology related to vision and safety is developing rapidly. It is expected that most vehicles sold after year 2017 will be equipped with a front camera, mandated for driving safety. Such cameras can be used to increase the volume of vehicular communication traffic, by having vehicles with vehicular communication technology deliver information about vehicles without vehicular communication technology, in an operation called “proxy transmission” (or simply, as used herein, “proxy”). Since vehicular communication is also referred to as “vehicle-to-everything” or “V2X” communication, a vehicle having such communication capability is referred to henceforth as “V2X vehicle”, while a vehicle lacking such capability is referred to henceforth as “non-V2X vehicle”. Sensors other than cameras, for example radar-based or LIDAR, can be useful for sensor related proxy operation as well. Henceforth, “camera” is used to cover all sensors (including radar-based, LIDAR and others) that can provide information on vehicles in proximity to a sensor-equipped vehicle. The latter executes a state-machine involved in various proxy operations and is referred to henceforth as “ego-vehicle”. A vehicle observed by an ego-vehicle camera is referred to as “observed vehicle”.

Vehicular proxy operation is not defined by current vehicular communication standards such as ETSI ITS G5 and IEEE1609. The art in the field is very limited. For example, vehicular proxy operation is described in US patent application 2013/0278441. However, the description therein is of an alternative solution not related to existing communication standards, the chances of which alternative solution being adopted are unclear. Moreover, US 2013/0278441 does not mention proxy control, i.e. with selection of a proxy server and control of proxy activation (see description below for the explanation/definition of these terms).

### SUMMARY

Embodiments disclosed herein relate to proxy operation (i.e. proxy control and proxy transmission) in vehicular communications.

In an embodiment there is provided a method for proxy operation in a vehicular environment that includes a first plurality of V2X ego-vehicles with respective sensors and a second plurality of non-V2X vehicles, the method comprising the steps of, in an ego-vehicle, determining that a particular vehicle observed by the respective ego-vehicle sensor is a non-V2X, proxy target vehicle, electing the ego-vehicle as a proxy server for the proxy target vehicle, and performing proxy transmission for the proxy target vehicle.

In an embodiment there is provided apparatus for proxy operation in a vehicular environment that includes a first plurality of V2X ego-vehicles with respective sensors and a second plurality of non-V2X vehicles, the apparatus comprising, in each ego-vehicle, a sensor unit for observing other vehicles and for providing sensor data on at least one observed vehicle, a proxy control module configured to receive the sensor data on the at least one observed vehicle together with data transmitted by other vehicles, process the sensor data together with the transmitted data, determine that an observed vehicle is a proxy target and perform a proxy-server election, a proxy transmission module configured to prepare a proxy transmission message related to the proxy target under the control of the proxy control module, and a communication unit for broadcasting the proxy transmission message.

In an embodiment there is provided a non-transitory computer readable medium having stored therein computer executable instructions for performing a method for proxy operation in a vehicular environment that includes a first plurality of V2X ego-vehicles with respective sensors and a second plurality of non-V2X vehicles, the computer readable medium installed in an ego-vehicle and comprising instructions for determining that a particular vehicle observed by the respective ego-vehicle sensor is a non-V2X, proxy target vehicle, instructions for electing the ego-vehicle as a proxy server for the proxy target vehicle, and instructions for controlling proxy transmission by the proxy server for the proxy target vehicle.

### BRIEF DESCRIPTION OF THE DRAWINGS

Non-limiting embodiments are herein described, by way of example only, with reference to the accompanying drawings, wherein:

FIG. 1A shows schematically vehicles with and without V2X technology driving on a road;

FIG. 1B shows schematically non-V2X vehicles in FIG. 1A that are “proxy targets” being observed by the V2X-vehicles;

FIG. 1C shows schematically a vehicle elected to be a “proxy server” performing proxy for two “proxy client” vehicles;

FIG. 2 illustrates a high level flow diagram of proxy operation, according to an embodiment of a method disclosed herein;

FIG. 3 illustrates schematically a process of determination if an observed vehicle is a V2X vehicle;

FIG. 4 shows schematically a process run by a state machine to determine if a vehicle transmits its location;

FIG. 5 shows a flow diagram of an explicit election protocol;

FIG. 6 shows a flow diagram of an implicit election protocol;

FIG. 7A illustrates an election extension to a standard packet format;

FIG. 7B illustrates an election and proxy client extension to a standard packet format;

FIG. 8 illustrates an apparatus for proxy operation in vehicular communications disclosed herein.

### DETAILED DESCRIPTION

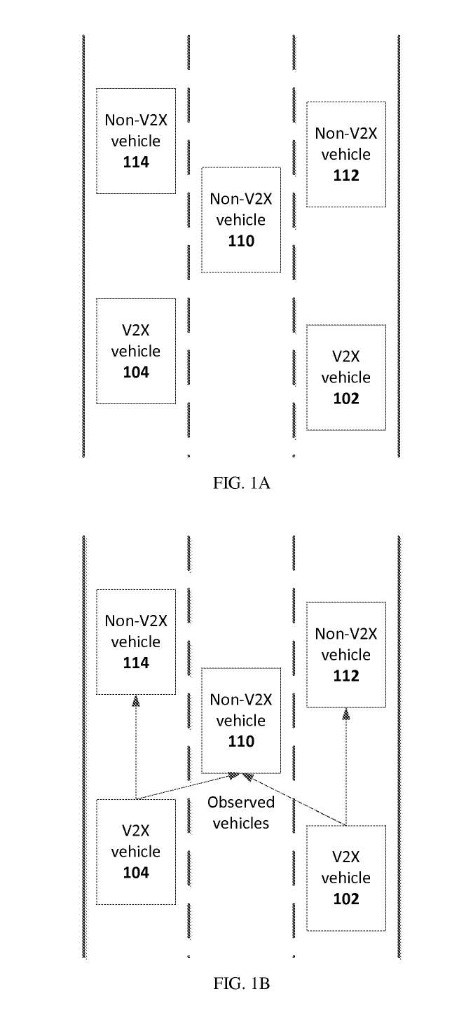

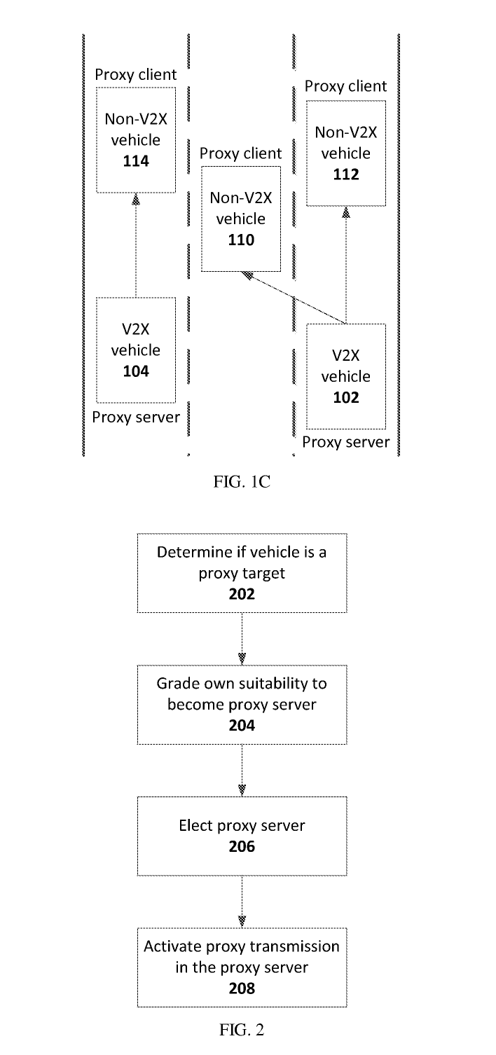

Terminology used herein and problems related to proxy operation are described now with reference to FIGS. 1A-1C. FIG. 1A shows schematically five vehicles driving on a road in the same direction: two vehicles, 102 and 104, are front-camera equipped V2X vehicles and three vehicles ahead, 110, 112 and 114 are non-V2X vehicles. FIG. 1B shows vehicles 110, 112 and 114 being “observed” by vehicles 102 and 104, where vehicle 102 observes vehicles 110 and 114 and vehicle 104 observes vehicles 110 and 112. Since vehicles 110, 112 and 114 do not have vehicular communication capability, proxy of these vehicles may be performed by vehicle 102 and/or vehicle 104. Accordingly, vehicles 110, 112 and 114 are potential “proxy targets”. FIG. 1C shows a situation in which vehicle 102 is elected to be a “proxy server” that performs proxy transmissions for vehicles 110, 112 and 114, which in turn become “proxy clients” when proxy transmission is performed for each. Note that the sequence of FIGS. 1A-1C also reflects a time sequence.

In vehicular proxy operation, a first challenge is to detect if a vehicle has vehicular communication equipment. Once understood that a vehicle is a non-V2X vehicle and once a non-V2X vehicle is identified as a proxy target, a second challenge emerges to ensure that only a single V2X vehicle performs the proxy, i.e. acts as a proxy server to a specific proxy client. This is needed to avoid a potential scenario in which two V2X vehicles, for example vehicles 102 and 104 above, act as proxy servers for a single proxy client (e.g. for vehicle 110), although only vehicle 102 is elected to be a proxy server (see more on the “election” process below). Yet another challenge involves proxy continuity. Since a vehicular environment is dynamic, proxy operation (transmission) may be short lived, and there is a need to maximize its duration.

FIG. 2 illustrates a high level flow diagram of proxy operation, according to an embodiment of a method disclosed herein. In step 202, a determination is made by an ego-vehicle if a vehicle observed by its camera is a proxy target (i.e. if it is a non-V2X vehicle). In step 204, the ego-vehicle grades its own suitability to become a proxy server. As used herein, “suitability” refers to the ability of the proxy server vehicle to perform proxy for an extended period of time. Note that a proxy target is a target for many ego-vehicles, but that only one such vehicle should be elected as a proxy server. A grading mechanism selects the best proxy server, while the proxy target becomes a proxy client, i.e. a non-V2X vehicle for which proxy is performed by an elected proxy server. In step 206, a distributed algorithm running on each ego-vehicle state-machine handles the proxy server election process. Each ego-vehicle handles its own election process, hoping to reach network wide consensus. An ego-vehicle with a highest “election grade” (highest suitability) is elected as proxy server. In step 208, the elected proxy server is activated, i.e. performs proxy transmission. Although the arrows in FIG. 2 show a sequential process from one step to another, some of the actions are continuous. For example, in some election protocols, the actions in steps 202 and 204 can be running and impacting constantly the following steps.

In some embodiments of the method of FIG. 2, step 204 may be optional. However, without a grading mechanism, the decision on the vehicle selected as proxy server in step 206 may be sub-optimal. All four steps are run by the state machine in each ego-vehicle, but only one ego-vehicle is elected as proxy server in step 206 and therefore performs step 208.

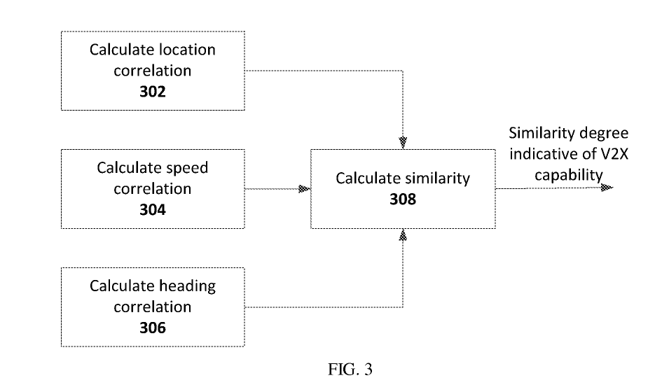

The various steps in FIG. 2 are now described in more detail with reference to FIGS. 3-6.

### Determination by a Given Ego-Vehicle if an Observed Vehicle has V2X Communication

FIG. 3 illustrates schematically a process that determines whether an observed vehicle is a V2X vehicle or a non-V2X vehicle. The process includes calculation of a similarity degree between information received from the front camera of an ego-vehicle and information received via vehicular communication from the observed vehicle and/or from other vehicles within range. A high similarity degree indicates a high likelihood that the observed vehicle transmits its location, i.e. is a V2X vehicle. A low similarity degree indicates the opposite, in which case the observed vehicle becomes a proxy target.

Note that the ego-vehicle receives communications from, and observes more than one observed vehicle, and that similarity calculations are performed for each respective observed vehicle. That is, similarity is measured between information received via vehicular communication and camera-based information obtained on all relevant observed vehicles within proximity to the location reported by vehicular communication.

The similarity calculation is based on a number of correlations. Exemplarily, as shown in FIG. 3, there may be three correlation calculations, each for a different parameter. In general, correlations may be calculated for additional parameters (for example, vehicle size, lights status, vehicle type), if such parameters are available. Each correlation calculation should take into account measurement (e.g. GPS) errors and/or sensor errors.

Many correlation functions may be useful for calculations described below. Typically, a correlation function output value is defined in a range between 0 and 1, where 0 indicates no correlation and 1 indicates maximal correlation. In general, other output ranges may be defined. The correlation functions below are exemplary, aiming to be simple and effective.

A location correlation value F1 is calculated in step 302. A simple calculation may use the equation:

F₁=max[0, 1−Distance Difference/(2*MaxDistanceError)] (1)

where “Distance Difference”=location detected by sensor−location detected by vehicular communication, and MaxDistanceError is a scaling parameter that can be adjusted for the GPS error in a specific scenario. For example, MaxDistanceError can be set to 3 m in highway driving or to 15 m in an urban environment. To clarify, the subtraction of the locations may involve a (X, Y) or (X, Y, Z) vector subtraction, where the location detected by the sensor is (X1, Y1) or (X1, Y1, Z1) and that reported by vehicular communication is (X2, Y2) or (X2, Y2, Z2). The location is referenced to the vehicle frame. The vectors represent typically (vertical distance, lateral distance) although representation of (distance, angle) is possible as well.

In an example, the camera detects a vehicle at (30 m vertical, 5 m lateral) and location communication is received for an object at (32 m vertical, 6 m lateral). In this case, the Distance Difference is (√(2²+1) i.e. 2.2 m. If MaxDistanceError is 5 m, then F₁ is 1− 2.2/10, or 0.78.

A speed correlation value Fₛ is calculated in step 304. A simple calculation may use the equation:

Fₕ=max[0, 1−abs(Speed Difference)/MaxSpeedError] (2)

where Speed Difference=speed detected by sensor−speed reported by vehicular communication and where MaxSpeedError is exemplarily ˜5-8 km/h. In an example, the speed detected by the camera is 48 km/h, while the speed reported by vehicular communication is 46 km/h. If MaxSpeedError is 8 km/h, then Fs=1− 2/8=0.75.

A heading correlation value Fₕ is calculated in step 306. A simple calculation may use the equation:

Fₕ=max[0, 1−abs(Heading Difference)/MaxHeadingError] (3)

where Heading Difference=heading detected by sensor−heading reported by vehicular communication and where MaxHeadingError is exemplarily ˜10-20 degrees.

In an example, the heading detected by the camera is 0 degrees, while the heading reported by communication is 5 degrees, i.e. Heading Difference=5 degrees. If MaxHeadingError is 20, then Fₕ=1− 5/20=0.75.

An overall correlation value is calculated from all the correlation values in step 308. A simple calculation that provides an overall correlation may use the equation:

Overall correlation=F_{d}*Fₛ*Fₕ (4)

In an example using the correlation values calculated above, the overall correlation value is 0.78*0.75*0.75=0.438. The overall correlation value is used to calculate a similarity value over time.

On one hand, a low overall correlation value is more meaningful than a high overall correlation value for a decision of an ego-vehicle to be elected as proxy server, and should be carried for longer period of time, impacting more significantly the outcome. On the other hand, a long-term similarity calculation should recover from a single low correlation value, i.e. should not be biased due to temporary error.

Several different long-term similarity equations can be defined. Exemplarily, a simple and effective long-term similarity equation (that serves as a filter to average the similarity over time) may be:

Similarity=min[1,(Overall Correlation+recovery parameter)*(Similarity+recovery parameter/2)] (5)

where the “recovery parameter” reflects the ability of the filter to rise from a low value. Exemplarily, a starting value for similarity may be between 0.2 and 0.4.

In some embodiments, the recovery parameter may be dynamic and may change when the proxy target vehicle is chosen as proxy client. In some embodiments, the recovery parameter may be set as a static value. For example, a recovery parameter value of 0.2 provides quick detection of a single event of lack of correlation (for example, a case in which the overall correlation value is high, but for some reason the location is erroneous and causes a temporary drop in the correlation value) but still allows recovery after 10 cycles (or 1 second). The recovery parameter value may be set higher, for example to 0.4, if the observed vehicle is not reported as proxy client or if the ego-vehicle is not a proxy server, because it would take extra caution to suddenly start and activate proxy. Note however that such sudden start and proxy activation may happen if another proxy server vehicle performing proxy stops doing so. In some embodiments, the similarity may be calculated without the use of a recovery parameter, e.g. by an alternative equation.

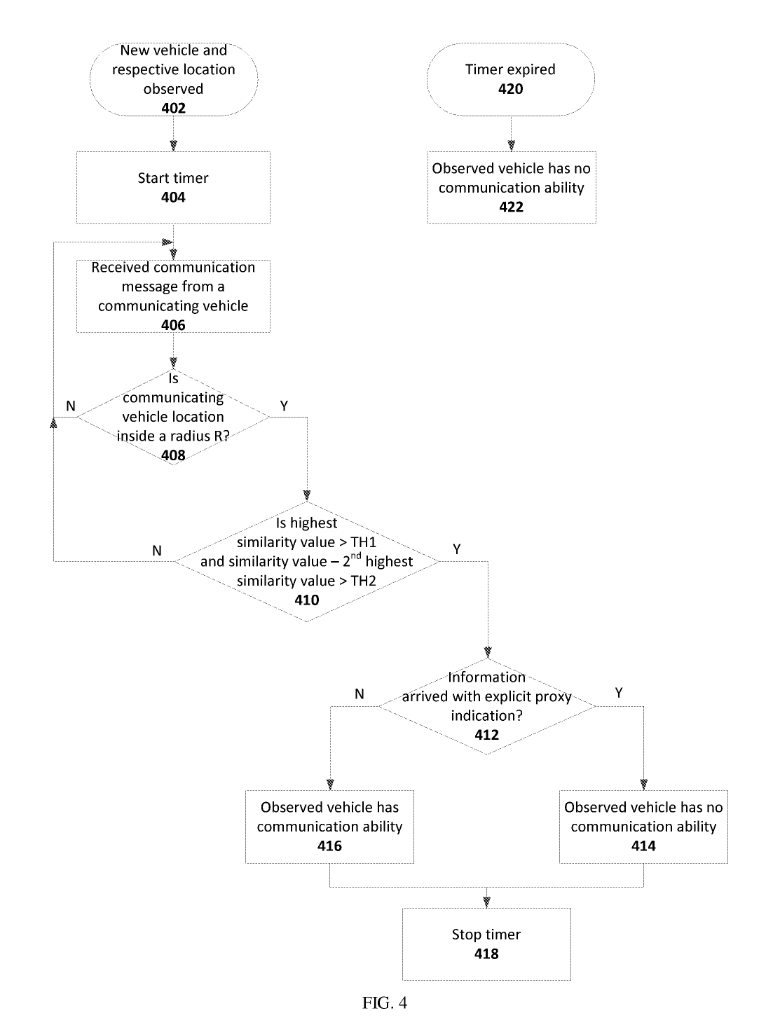

In an example of how quickly the similarity value may drop and how long it may take it to recover, the similarity value is 0.9 and the recovery parameter value is 0.3. With an overall correlation value of 0.2, the similarity value drops to min[1,(0.2+0.2)*(0.9+0.1)]=0.4. Assume that the overall correlation value then returns to 0.9, and the next calculation yields a similarity value of min(1,(0.9+0.2)*(0.4+0.1))=0.55. This value is then used in the process illustrated in FIG. 4.

In some scenarios, two vehicles observed by a camera, one a V2X vehicle and the other a non-V2X vehicle, may exhibit identical similarity values for received vehicular communications. The challenge is to know which of the two observed vehicles is the V2X vehicle, if, for example, the two observed vehicles are separated by a distance smaller than the GPS error. This scenario is handled by the process illustrated in FIG. 4.

FIG. 4 shows schematically a process run by a state machine to determine if a vehicle transmits its location, i.e. if it is a V2X vehicle. Operation begins in step 402 when a new vehicle and its location are observed by an ego-vehicle camera. Alternatively, the state machine can force beginning of operation. A timer is started in step 404. The timer value depends on a configuration parameter and can vary exemplarily between 0.5 second to 10 seconds. In step 406, a vehicular communication message is received at the ego-vehicle. In step 408, a check is made to determine whether a location included in the communication message (“communicated location”) is within a radius R from the location of a particular observed vehicle. The value of R can be static, for example 15 meters, or may be dynamic, adjusted to expected GPS error. If the communicated location is not within radius R (i.e. the message did not come from the particular observed vehicle), operation returns to step 406, meaning that the received communication is ignored. Otherwise, operation continues to step 410. A highest similarity value is calculated (exemplarily using eqn. (5)) and is compared with a first threshold TH1 value. A difference between the highest calculated similarity value and a 2^{nd} highest similarity value is compared with a second threshold TH2 value. For example, TH1 may equal 0.8, and TH2 may equal 0.2. If both comparisons in step 410 are true, then the particular observed vehicle most likely transmits its location, i.e. it may be a V2X vehicle.

Operation continues to step 412, where a check is made if the message arrived with an explicit proxy indication (see the description of proxy operation related to FIG. 7). The existence of such explicit proxy notification means that the received transmission is from another proxy server, not from the particular observed vehicle. Consequently, if YES in step 412, then the particular observed vehicle is declared in step 414 as not having communication ability. If NO in step 412, then the observed vehicle is declared in step 416 as having communication ability. Both steps 414 and 416 lead to step 418, where the timer is stopped and no further operations are needed. Upon timer expiration, in step 420, it is assumed that the particular observed vehicle does not transmit its location, and this is declared in step 422.

Returning to step 410, if either or both conditions are not fulfilled, no conclusive can decision is made, and operation returns to step 406. Note that the operation in step 410 declares similarity only if there is a definite identification of the source of the information. The availability of an explicit proxy indication allows clear identification of the observed vehicle being a non-V2X vehicle

### Self-Grading by Ego-Vehicle of its Own Suitability to Become a Proxy Server

As mentioned, step 204 provides an “election grade” that indicates the suitability of the ego-vehicle to be elected as proxy server. Several parameters may be considered, such as distance, differential speed between the ego-vehicle and the proxy target vehicle or other current properties of the ego-vehicle and the proxy target vehicle. However, the scheme proposed here simplifies on one hand the calculation by considering only the location of the ego- and proxy target vehicles and distances therebetween, while on the other hand provides a more accurate estimation by considering also a future relative location of the two. An exemplary equation for calculating the election grade may be:

Gd=max[0, 1−abs(current distance−target distance)/(2*target distance)−abs(future distance−target distance)/(2*target distance)+abs(lateral distance)/lateral factor] (6)

where “target distance” marks an optimal distance between the ego-vehicle and the proxy target vehicle and “lateral distance” marks the distance on the lateral axis between the two vehicles. The target distance may have a dynamic value based on the environment, for example 30 meters in an urban environment and 100 meters on a highway. It is set sufficiently ahead to allow coping with a faster ego-vehicle, but not too far ahead, to allow coping with a slower ego-vehicle. “Lateral distance” is considered to prefer target vehicles in the same lane (in which case, its value is 0). “Lateral factor” is the weight assigned for lateral deviation. It determines if vehicles with high lateral distance will be elected. The lateral factor may be exemplarily in a range of 5 to 20. Exemplarily, a lateral factor of 10 assures that only vehicles adjacent to the ego-vehicle will be eligible for proxy. In the early state of the V2X market, V2X penetration is lower, and a V2X vehicle is expected to serve as proxy server for several vehicles. In this case, the lateral factor should be high (20) to consider many proxy targets. Once the market matures (and more vehicles become V2X), the need for proxy will decrease, and the lateral factor can decrease to allow more selectiveness in the proxy selection process.

In an example, the target distance is exemplarily 30 meters, the current distance between vehicles is exemplarily 50 meters, and the future distance will become exemplarily 20 meters in 10 seconds. The lateral distance is 0 meters. The lateral factor is exemplarily 10 m. The resulting election grade is 1−abs(50−30)/2*30−abs(20−30)/2*30−abs(0/10)=1−⅓−⅙−0=0.5. The election grade becomes better as it approaches a value of 1.

If the future location is no longer observed by the ego-vehicle, the grade (Gd in eq (6)) is set to zero. Other equations may consider differently a lateral distance for vehicles on left than vehicles on right of the observed vehicle. For example, in right side driving, vehicles on the left can receive higher preference to be selected for proxy operation by assigning a lower lateral factor.

### Proxy Server Election

As mentioned, step 206 performs the election of the proxy server. Well-studied election protocols from the field of computer networks may be applied here. Two exemplary ones are described next: a) a “bully” algorithm, requiring explicit handshake between units in a particular ego-vehicle and another vehicle that aims to be a proxy server, and b) an algorithm without handshake.

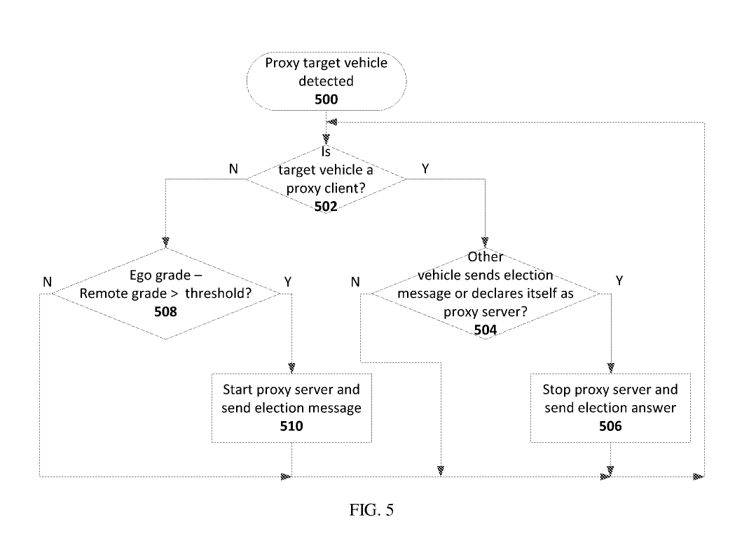

An explicit handshake is described in FIG. 5. Operation begins in step 500, after a proxy target vehicle is detected using steps 414 and 422 in FIG. 4. In step 502, a check is made if proxy transmission takes place for the proxy target. If YES, a subsequent check in step 504 checks if another vehicle sent an election message (i.e. if another vehicle decided to elect itself as proxy server or sent a proxy transmission message (i.e. an explicit or implicit proxy notification causing the transmitting vehicle to be perceived as having V2X ability, and no longer a proxy target). If YES, then in step 506 the particular ego-vehicle stops acting as proxy server and an election answer is broadcast to indicate that the proxy transmission is stopped. The election message and answer are included in an “election control” field, see FIGS. 7A and 7B. If the check in step 502 shows that no proxy transmission takes place for the proxy target vehicle, operation continues to step 508, where a check is performed to determine whether the election grade of particular ego-vehicle acting as proxy server is higher than that of other candidates for proxy servers by a third threshold TH3, for example, 0.2. This hysteresis prevents frequent changes of the proxy server. If the check is true (YES), operation continues from step 510, where proxy transmission begins and an election message is broadcast. If the check is false (NO), then operation returns to step 502.

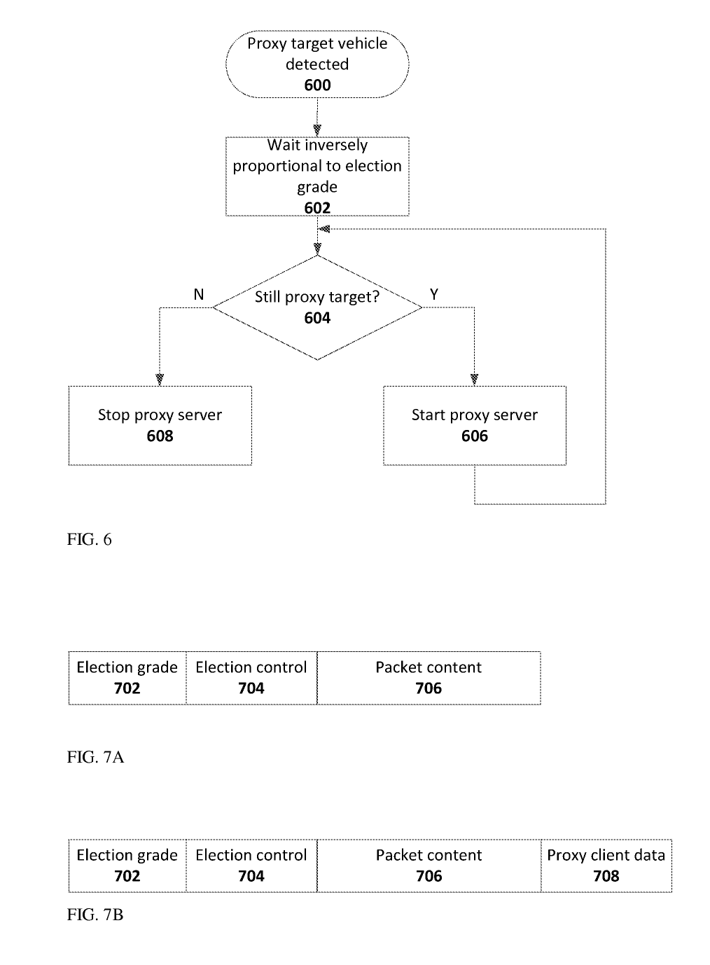

An implicit handshake is described in FIG. 6. Operation begins in step 600 after a proxy target is detected. In step 602, an ego-vehicle desiring to act as proxy server waits for a period inversely proportional to an election grade. For example, if the election grade is 1, then no wait is needed. If the election grade is exemplarily 0.1, then a wait of typically 2-4 seconds is implemented by a state-machine as in FIG. 6, running in the ego-vehicle. In step 604, a check validates if the proxy target vehicle is still qualified as such by running the state machine of FIG. 4. If YES, then the ego-vehicle desiring to act as proxy server is elected and starts to act as such (i.e. a proxy server is activated) in step 606, from which operation returns to step 604. If NO, then the proxy server is deactivated in step 608 (in case it was activated previously, see loop).

### Proxy Transmission

Three models can be applied to proxy transmission: explicit proxy transmission with a dedicated packet format, explicit proxy transmission with an overloaded packet format and implicit proxy transmission with a standard packet format.

Explicit proxy transmission with a dedicated packet format extends the standard packet format with commonly agreed fields for the proxy operation. An exemplary packet format in which a standard packet format is extended with an election extension is described in FIG. 7A. Original packet content 706 (defined by vehicular communication standards) is extended with fields for managing the proxy operation. Field 702 holds the election grade (calculated using eq. 6). Field 704 holds the election control, for example, an election message flag.

Explicit proxy can also be represented by adding a “proxy clients” field to the current packet format, as shown in FIG. 7B. The figure illustrates an election and proxy client extension to a standard packet format. Field 708 contains the information of the proxy clients.

Explicit proxy transmission with an overloaded packet format provides the added election and proxy client information without modifying the standard packet format. The proxy server sends a standard packet using the proxy client properties. Instead of adding new fields, existing fields in a standard packet format receive new meaning. For example, the vehicle length field is not provided by the camera. Instead, that field can carry election data, as long as the maximal value of the election grade (calculated in equation 6) when considered using vehicle length units is smaller than the shortest vehicle length. That is, the minimal value of vehicle length should be greater than the maximal value of the control field.

A standard packet format, as defined by the relevant standardization groups, is used in implicit proxy. No indication exists for proxy operation. A packet carrying the proxy client information is received like any other packet. The complex part is the proxy election, but any proxy server election algorithm must deal with a scenario that somehow another vehicle is also proxying for the same proxy client. In this case, proxy transmission stops immediately.

A significant advantage of explicit proxy is the ability to perform smooth handoff. A new proxy server may continue from a previous proxy server using the same pseudo-vehicle identity and continue the “path history” field (a field that carries description of the historical path driven by the vehicle). This provides continuity, which is well appreciated when proxying for vehicles of an opposite lane, since proxy operation for an opposite lane can survive for just a few seconds. Smooth handoff is not possible with implicit proxy.

### Apparatus

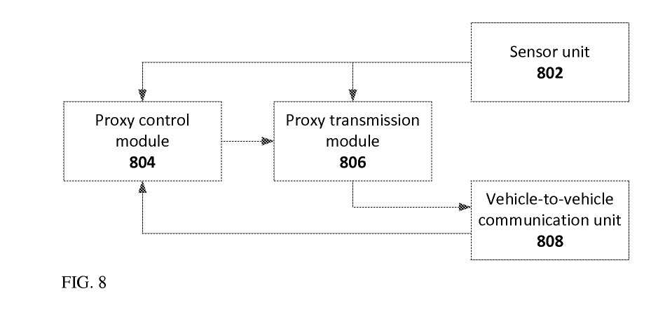

FIG. 8 shows schematically in a block diagram an embodiment numbered 800 of an apparatus for proxy operation in vehicular communications disclosed herein. Apparatus of this type may be installed in each V2V vehicle. Apparatus 800 includes a sensor unit 802 a sensor unit for observing other vehicles and for providing sensor data (e.g. location, speed, heading) on at least one observed vehicle, a proxy control module 804 configured to receive the sensor data on the at least one observed vehicle together with data transmitted by other vehicles, process the sensor data together with the transmitted data, determine that an observed vehicle is a proxy target and perform a proxy-server election, a proxy transmission module 806 configured to prepare a proxy transmission message related to the proxy target under the control of the proxy control module, and a communication unit 808 that performs vehicle-to-vehicle communication, including broadcasting proxy transmission messages. Exemplarily, modules 804 and 806 may run on a processor, for example a central processing unit (CPU).

The various features and steps discussed above, as well as other known equivalents for each such feature or step, can be mixed and matched by one of ordinary skill in this art to perform methods and techniques in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein. For example, any digital computer system can be configured or otherwise programmed to implement the methods and techniques disclosed herein, and to the extent that a particular digital computer system is configured to implement the methods and techniques disclosed herein, it is within the scope and spirit of the disclosed embodiments. Once a digital computer system is programmed to perform particular functions pursuant to computer-executable instructions from program software that implements the method embodiments disclosed herein, it in effect becomes a special purpose computer particular to the method embodiments disclosed herein. The techniques necessary to achieve this are well known to those skilled in the art and thus are not further described herein.

Computer executable instructions implementing the methods and techniques disclosed herein can be distributed to users on a non-transitory computer-readable medium and are often copied onto a hard disk or other storage medium. When such a program of instructions is to be executed, it is usually loaded into the random access memory of the computer, thereby configuring the computer to act in accordance with the techniques disclosed herein. All these operations are well known to those skilled in the art and thus are not further described herein. The term “non-transitory computer-readable medium” encompasses distribution media, intermediate storage media, execution memory of a computer, and any other medium or device capable of storing for later reading by a computer a computer program implementing method embodiments disclosed herein.

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

What is claimed is:

1. A method for proxy operation in a vehicular environment that includes a first plurality of ego-vehicles having vehicular communication capability (V2X vehicles) and respective sensors and a second plurality of vehicles without vehicular communication capability (non-V2X vehicles), the method comprising the steps of: in an ego-vehicle:
a) determining that a particular vehicle observed by the respective ego-vehicle sensor is a non-V2X, proxy target vehicle;
b) electing the ego-vehicle as a proxy server for the proxy target vehicle; and
c) performing proxy transmission for the proxy target vehicle.

2. The method of claim 1, wherein the respective sensor is a camera and wherein the step of determining that a particular vehicle observed by the respective ego-vehicle camera is a proxy target vehicle includes determining a similarity value between camera-based information and vehicular communication-based information received at the ego-vehicle.

3. The method of claim 2, wherein the determining a similarity degree includes calculating a similarity value based on an overall correlation value.

4. The method of claim 3, wherein the overall correlation value is calculated using a plurality of correlation values, each correlation value calculated using a result of a subtraction between a motion parameter of the ego-vehicle and a motion parameter of the proxy target vehicle.

5. The method of claim 4, wherein the parameters include vehicle location, vehicle speed and vehicle heading, and wherein the overall correlation value includes a product of a location correlation value, a speed correlation value and a heading correlation value.

6. The method of claim 1, wherein the step of electing the ego-vehicle as a proxy server for the proxy target vehicle includes determining that the ego-vehicle has a highest election grade.

7. The method of claim 2, wherein the step of determining that a particular vehicle observed by the respective ego-vehicle camera is a proxy target vehicle further comprises determining that a highest similarity value is greater than a first threshold, that a difference between the highest similarity value and a second highest similarity value is greater than a second threshold, and that the vehicular communication-based information does not include an explicit proxy indication.

8. The method of claim 1, wherein the step of performing proxy transmission includes performing explicit proxy transmission with a dedicated packet format.

9. The method of claim 1, wherein the step of performing proxy transmission includes performing explicit proxy transmission with an overloaded packet format.

10. The method of claim 1, wherein the step of performing proxy transmission includes performing implicit proxy transmission with standard packet format.

11. Apparatus for proxy operation in a vehicular environment that includes a first plurality of ego-vehicles having vehicular communication capability (V2X vehicles) and respective sensors and a second plurality of vehicles without vehicular communication capability (non-V2X vehicles), the apparatus comprising: in an ego-vehicle:
a) a sensor unit for observing other vehicles and for providing sensor data on at least one observed vehicle;
b) a proxy control module configured to receive the sensor data on the at least one observed vehicle together with data transmitted by other vehicles, process the sensor data together with the transmitted data, determine that an observed vehicle is a proxy target and perform a proxy-server election;
c) a proxy transmission module configured to prepare a proxy transmission message related to the proxy target under the control of the proxy control module; and
d) a communication unit for broadcasting the proxy transmission message.

12. The apparatus of claim 11, wherein the sensor unit includes a front-camera.

13. The apparatus of claim 11, wherein the sensor unit includes a radar unit.

14. The apparatus of claim 11, wherein the sensor unit includes a LIDAR unit.

15. The apparatus of claim 11, wherein the proxy transmission module is configured to convert sensor data to V2X data.

16. The apparatus of claim 11, wherein the proxy control module includes a central processing unit that runs a plurality of state machines.

17. The apparatus of claim 11, wherein the proxy transmission is an explicit proxy transmission and wherein the proxy transmission message includes a packet with a dedicated packet format.

18. The apparatus of claim 11, wherein the proxy transmission is an explicit proxy transmission and wherein the proxy transmission message includes a packet with an overloaded packet format.

19. The apparatus of claim 11, wherein the proxy transmission is an implicit proxy transmission and wherein the proxy transmission message includes a packet with a standard packet format.

20. A non-transitory computer readable medium having stored therein computer executable instructions for performing a method for proxy operation in a vehicular environment that includes a first plurality of ego-vehicles having vehicular communication capability (V2X vehicles) and respective sensors and a second plurality of vehicles without vehicular communication capability (non-V2X vehicles), the computer readable medium installed in an ego-vehicle and comprising:
a) instructions for determining that a particular vehicle observed by the respective ego-vehicle sensor is a non-V2X, proxy target vehicle;
b) instructions for electing the ego-vehicle as a proxy server for the proxy target vehicle; and
c) instructions for controlling proxy transmission by the proxy server for the proxy target vehicle.
